(19) United States
(12) Patent Application Publication
(10) Pub. No.: US 2023/0014095 A1
(43) Pub. Date: Jan. 19, 2023

(54) METHOD AND SYSTEM FOR RECOGNIZING ENVIRONMENTAL PROTECTION EQUIPMENT BASED ON DEEP HIERARCHICAL FUZZY ALGORITHM

(71) Applicant: Shandong Jianzhu University, Jinan, Shandong (CN)

(72) Inventors: Chengdong Li, Shandong (CN); Xiaoping Deng, Shandong (CN); Guiqing Zhang, Shandong (CN); Qiao Yan, Shandong (CN)

(21) Appl. No.: 17/782,792

(22) PCT Filed: Nov. 27, 2020
(86) PCT No.: PCT/CN2020/132231

§ 371 Date: Jun. 6, 2022

(30) Foreign Application Priority Data
Jun. 24, 2020 (CN) 202010588932.8

(51) Int. Cl. G06N 3/04; G06N 3/08

(52) U.S. Cl. CPC G06N 3/0472; G06N 3/08

(57) ABSTRACT

A method and system for recognizing environmental protection equipment based on a deep hierarchical fuzzy algorithm. The method includes the following steps: (1) acquiring harmonic signal data of the environmental protection equipment by harmonic detectors, and acquiring type information of corresponding environmental protection equipment on site for constructing a training sample database; (2) extracting a feature vector of the data in the training sample database by a local mean decomposition method, and training, by using the training sample database, a deep hierarchical fuzzy system constructed on the basis of a least square method, so as to construct a recognition model; and (3) evaluating the inputted harmonic signal data by using the recognition model to determine whether inspected equipment is the corresponding environmental protection equipment.

This patent application claims the benefit and priority of Chinese Patent Application No. 202010588932.8, filed on Jun. 24, 2020, the disclosure of which is incorporated by reference herein in its entirety as part of the present application.

### TECHNICAL FIELD

The present disclosure relates to recognition of environmental protection equipment, and specifically to a method for recognizing, by analyzing power utilization data of equipment, whether the equipment is corresponding environmental protection equipment, which belongs to the field of data mining and analysis.

### BACKGROUND ART

The statements herein merely provide background art related to the present disclosure and do not necessarily constitute the prior art.

In recent years, corporate environmental protection issues have received special attention, and the state has continuously revised the Environmental Protection Law to strengthen environmental supervision. On the enterprise side, the provision of necessary environmental pollution control equipment is the basis for enterprises to meet environmental protection standards. Law enforcement officers of the environmental protection department will also conduct daily inspections on the environmental protection equipment of the enterprises.

At present, when inspecting the environmental protection equipment of the enterprises, the law enforcement officers need to visit the site in person. Due to a large number of enterprises and projects that need to be inspected, the law enforcement officers in some regions are perfunctory when inspecting the environmental protection equipment of the enterprises. Since turning on the environmental protection equipment will increase production costs of the enterprises, many enterprises only turn on the environmental protection equipment before the inspection starts in order to cope with the inspection. There are some enterprises shutting down the environmental protection equipment after the law enforcement officers leave, although the equipment is running well during the inspection and all inspections meet the standard requirements. The method for inspecting by using a harmonic detector has the problem that an instrument is secretly replaced and mounted on other non-environmental protection equipment. Through some of the existing phenomena, it can be found that there are defects in the daily inspection methods of the environmental protection department for the environmental protection equipment of the enterprises.

### SUMMARY

For the shortcomings in the prior art, to accurately and quickly solve the existing problems in the daily inspection of environmental protection equipment, the present disclosure provides a method and system that can recognize environmental protection equipment in real time.

To achieve the above objective, the present disclosure is achieved by the following technical solutions:

According to a first aspect, embodiments of the present disclosure provide a method for recognizing environmental protection equipment based on a deep hierarchical fuzzy algorithm, including the following steps:

(1) acquiring harmonic signal data of the environmental protection equipment by harmonic detectors, and acquiring type information of corresponding environmental protection equipment on site for constructing a training sample database;

(2) extracting a feature vector of the data in the training sample database by a local mean decomposition method, and training, by using the training sample database, a deep hierarchical fuzzy system constructed on the basis of a least square method, so as to construct a recognition model; and

(3) evaluating the inputted harmonic signal data by using the recognition model to determine whether inspected equipment is the corresponding environmental protection equipment.

In an embodiment, step (1) includes the following sub-steps:

acquiring several signal cycles of harmonic signal data xₘ(t), and then uploading this data to a cloud platform;

collecting the type information of the environmental protection equipment corresponding to all the harmonic detectors (equipment nodes m(m=1, 2, . . . , n)), and taking a type of the equipment as a category label yₘ, where yₘ∈{1, 2, . . . , k, k+1} (k≤n), label 1, 2, . . . , k represents k different types of environmental protection equipment, label k+1 represents non-environmental protection equipment, and correspondence is: m⇔yₘ⇔xₘ(t); and

constructing the training sample database D by using the acquired harmonic signal data xₘ(t) and the category label yₘ corresponding to each harmonic signal data.

In an embodiment, step (2) includes the following sub-steps:

Sub-Step 1: Extraction of the Feature Vector

performing local mean decomposition on each harmonic signal xₘ(t) in the training sample database to obtain a PF component, taking PF₁, PF₂, PF₃ components, obtaining an instantaneous amplitude aᵣ(i) and an instantaneous frequency fᵣ(t) of the PFᵣ (r=1,2,3) component of the harmonic signal xₘ(t), and further obtaining respective mean values a̅ᵣ̅(̅t̅)̅ and f̅ᵣ̅(̅t̅)̅ by using a mean value method; and constructing the feature vector PF by using a̅ᵣ̅(̅t̅)̅ and f̅ᵣ̅(̅t̅)̅ of the PFᵣ component of the harmonic signal xₘ(t), that is, PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅)

Sub-Step 2: Building of the Deep Hierarchical Fuzzy System

first setting overall parameters of the system, and manually determining a number of layers L, a moving step s, and a length of a convolution window w;

taking the feature vector PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅) in the training sampling set D₁ as an input vector of the system, that is, (x₁⁰, x₂⁰, . . . , x₆⁰)=PFₘ, and taking the category label yₘ as an output vector of each fuzzy sub-system;

constructing an input-output data pair of an i-th fuzzy sub-system in a first layer: [x₍ᵢ₋₁₎ₛ₊₁⁰(m), xₛ₊ᵢ⁰(m), . . . , x_{(i-1)s+w}⁰(m); yₘ]; determining a range [min x⁰, max x⁰] of fuzzy sets according to the data pair, where in this range, the input vector can be further divided into q fuzzy sets A¹, A², . . . , A^{q},

the i-th fuzzy sub-system in the first layer can be represented as: FSᵢ¹(x₍ᵢ₋₁₎ₛ₊₁⁰, xₛ₊ᵢ⁰, . . . , x_{(i-1)s+w}⁰)→xᵢ¹, and an expression of xᵢ¹ can be further obtained by using an existing standard formula and simplified as:

$$\begin{matrix}{x}_{i}^{1} = {FS}_{i}^{1} ( {x}_{( i - 1 ) s + 1}^{0} , {x}_{s + i}^{0} , … , {x}_{( i - 1 ) s + w}^{0} ) \\ = {\sum }_{{j}_{1} = 1}^{q} L {\sum }_{{j}_{w} = 1}^{q} {c}^{{j}_{1} L} {}^{{j}_{w}} {A}^{{j}_{1}} ( {x}_{( i - 1 ) s + 1}^{0} ) L {A}^{{j}_{w}} ( {x}_{( i - 1 ) s + w}^{0} )\end{matrix}$$

designing the parameter c^{j}^{₁}^{Lj}^{_{w}} in the formula above by using the least square method and transforming same into:

min S(c)=min∥xᵢ¹−yₘ∥²

and obtaining an optimal solution thereof;

solving a parameter matrix c, completing the design of the i-th fuzzy sub-system in the first layer, and completing the building of fuzzy sub-systems in the first layer according to the method above; and

taking output xᵢ¹ of the first layer as the input vector of fuzzy sub-systems in a second layer, the output vector being still yₘ, and designing the fuzzy sub-systems in the second layer according to the same design method as that of the first layer; and so on, completing the design of fuzzy sub-systems in the last layer, and completing the building of the deep hierarchical fuzzy system.

In an embodiment, in step (2), the data in the training sample database D is divided into two parts: a training set D₁ and a test set D₂, and both the training set D₁ and the test set D₂ are subjected to the sub-step of extraction of the feature vector; by inputting the harmonic signal data in the test set D₂ into the recognition model and comparing a recognition result with the label, whether the accuracy of the recognition model can meet the requirement is tested. If the accuracy cannot meet the requirement, more sample data is needed to train the recognition model again until the accuracy can meet the requirement.

In an embodiment, in step (3), the harmonic signal data acquired from the inspected equipment is inputted into the constructed recognition model, this model first extracts the feature vector of the harmonic signal data and then inputs the extracted feature vector into the deep hierarchical fuzzy system to obtain the category label for determining whether the inspected equipment is the corresponding environmental protection equipment, and display equipment outputs the analyzed recognition result.

According to a second aspect, the embodiments of the present disclosure also provide a system for recognizing environmental protection equipment based on a deep hierarchical fuzzy algorithm, configured to perform, when being executed, the steps of the above method for recognizing environmental protection equipment based on a deep hierarchical fuzzy algorithm. The system includes:

a data acquisition module configured to perform step (1) of the method;

a recognition model construction module configured to perform step (2) of the method; and

a signal recognition module configured to perform step (3) of the method.

According to the present disclosure, the harmonic detectors mounted on the environmental protection equipment are configured to acquire harmonic signals of the equipment in real time, and whether the inspected equipment is the corresponding environmental protection equipment is determined by decomposing and recognizing the harmonic signals, which can indirectly reflect whether the environmental protection equipment is started. The present disclosure avoids cumbersome inspections by the law enforcement officers, and can avoid the problem that the enterprises secretly stop the environmental protection equipment and secretly replace the inspected equipment, thereby improving the efficiency of daily inspections of the environmental protection equipment, enhancing the strength of environmental protection inspections, and being conducive to the implementation of environmental protection policies.

The embodiments of the present disclosure have the following beneficial effects:

(1) equipment can be inspected in real time to determine whether the equipment is the corresponding environmental protection equipment, thereby avoiding the problems of secret replacement of an inspection instrument onto non-environmental protection equipment and type mismatch of the environmental protection equipment.

(2) This method also reflects in real time whether the environmental protection equipment is started, so as to avoid the problem of secretly stopping the environmental protection equipment.

(3) The cumbersomeness of daily inspections by the law enforcement officers is greatly reduced, the efficiency of daily inspections is improved, and the strength of environmental protection inspections is strengthened.

(4) The deep hierarchical fuzzy system designed on the basis of the least square method has better accuracy and calculation velocity, and solves the problem of curse of dimensionality rule explosion.

(5) An architecture of cloud-edge collaboration is adopted, which facilitates acquisition and centralized processing and analysis for data, and saves more resources than conventional methods.

### BRIEF DESCRIPTION OF THE DRAWINGS

The accompanying drawings which constitute a part of the description of the present disclosure are intended to provide further understanding of the present disclosure. The exemplary examples of the present disclosure and descriptions thereof are intended to explain the present disclosure and do not constitute an inappropriate limitation to the present disclosure.

FIG. 1 is a schematic diagram of a system architecture of cloud-edge collaboration according to the present disclosure;

FIG. 2 is a structural diagram of a deep hierarchical fuzzy system according to the present disclosure; and

FIG. 3 is a flowchart of recognition according to the present disclosure.

### DETAILED DESCRIPTION OF THE EMBODIMENTS

It should be noted that the following detailed description is exemplary and aims to further describe the present disclosure. Unless otherwise specified, all technical and scientific terms used in the present disclosure have the same meaning as commonly understood by one of ordinary skill in the technical field to which the present disclosure belongs.

It should be noted that the terms used herein are merely used for describing the specific implementations, but are not intended to limit exemplary implementations of the present disclosure. As used herein, the singular form is also intended to include the plural form unless otherwise indicated obviously in the present disclosure. Furthermore, it should be further understood that the terms “include” and/or “comprise” used in this specification specify the presence of features, steps, operations, devices, components and/or a combination thereof.

To accurately and quickly solve the problems existing in the existing daily inspections of environmental protection equipment, the present disclosure provides a deep hierarchical fuzzy algorithm method and system for recognizing environmental protection equipment, which combine an architecture of cloud-edge collaboration and a method of a deep hierarchical fuzzy system on the basis of a least square method. Harmonic detectors are mounted on environmental protection equipment of enterprises to acquire harmonic signal data of the environmental protection equipment, type information of the environmental protection equipment corresponding to each harmonic signal data is acquired through field investigation, and all the data information is transmitted to a “cloud platform” through a communication network. In the “cloud platform”, a training sample database is constructed by using the acquired data information, and a recognition model is constructed by combining a local mean decomposition method and the deep hierarchical fuzzy system. The acquired harmonic signal data is inputted into a recognition model for estimation to determine whether the inspected equipment is the corresponding environmental protection equipment.

The present disclosure includes three modules, namely a data acquisition module, a recognition model construction module, and a signal recognition module. The data acquisition module is responsible for acquiring harmonic signals of the environmental protection equipment by the harmonic detectors, uploading same to the “cloud platform”, and constructing the training sample database by combining actually surveyed type information of the environmental protection equipment. The recognition model construction module is configured to extract a feature vector of the data in the training sample database by a local mean decomposition method, and train, by using the training sample database, the deep hierarchical fuzzy system constructed on the basis of the least square method, so as to construct the recognition model. The signal recognition module is configured to evaluate the inputted harmonic signal data by using the recognition model to determine whether the inspected equipment is the corresponding environmental protection equipment.

The three modules are described in detail below:

Module 1: Data Acquisition Module

This module is responsible for acquiring the harmonic signal data of the equipment by using the harmonic detectors, acquiring the type information of the corresponding environmental protection equipment through field investigation, and uploading all the data information to the cloud platform through the communication network. The acquired data information is configured to construct the training sample database.

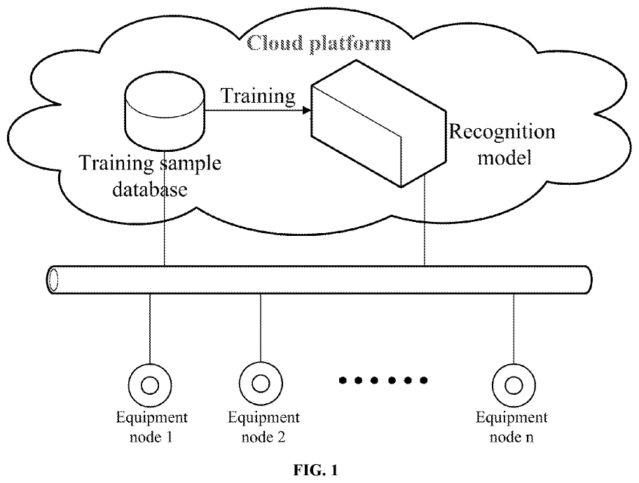

The system architecture of cloud-edge collaboration is adopted (the schematic diagram is shown in FIG. 1), 10 signal cycles of harmonic signal data xₘ(t) are acquired by using the harmonic detectors (equipment nodes m(m=1, 2, . . . , n)) mounted on the environmental protection equipment, where t refers to a continuous time value when the data is acquired, and this data is uploaded to the cloud platform through the communication network.

The type information of the environmental protection equipment corresponding to all the equipment nodes is collected through actual field investigation, and a type of the equipment taken as a category label yₘ, where yₘ∈{1, 2, . . . , k, k+1} (k≤n), the label 1, 2, . . . , k represents k different types of environmental protection equipment, label k+1 represents non-environmental protection equipment, and correspondence is: m⇔yₘ⇔xₘ(t).

In the cloud platform, the training sample database D is constructed by using the acquired harmonic signal data xₘ(t) and the category label yₘ corresponding to each harmonic signal data. This database is configured to construct and train the recognition model.

Module 2: Recognition Model Construction Module

This module is responsible for extracting a feature vector of the data in the training sample database by a local mean decomposition method, and classifying the harmonic signals by using the deep hierarchical fuzzy system constructed on the basis of the least square method, so as to construct the recognition model. This model is configured to recognize and analyze the harmonic signal data of the equipment needing to be inspected.

1. Extraction of the Feature Vector

The data in the training sample database D is divided into two parts: 80% of the data is a training set D₁, and the remaining data is a test set D₂.

Each harmonic signal xₘ(t) in the training sample database is subjected to local mean decomposition to obtain a PF component (an envelope signal and a pure frequency modulation signal are generated by the local mean decomposition method, and a final result PF (Production function) component is obtained through a product of the two. The PF component obtained from primary running can be recorded as a PF₁ component, after an original signal is subtracted by this component, local mean decomposition is performed again to obtain the PF₂ component; and so on), PF₁, PF₂, PF₃ components are taken, an instantaneous amplitude e aᵣ(t) and an instantaneous frequency fᵣ(t) of the PFᵣ (r=2,3) component of the harmonic signal xₘ(t) are obtained, and respective mean values a̅ᵣ̅(̅t̅)̅ and f̅ᵣ̅(̅t̅)̅ are further obtained by using a mean value method. The feature vector PFₘ is constructed by using aᵣ(t) and f̅ᵣ̅(̅t̅)̅ of the PFᵣ component of the harmonic signal xₘ(t), that is, PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅).

Both the training set D₁ and the test set D₂ are subjected to the data processing process.

2. Building of the Deep Hierarchical Fuzzy System

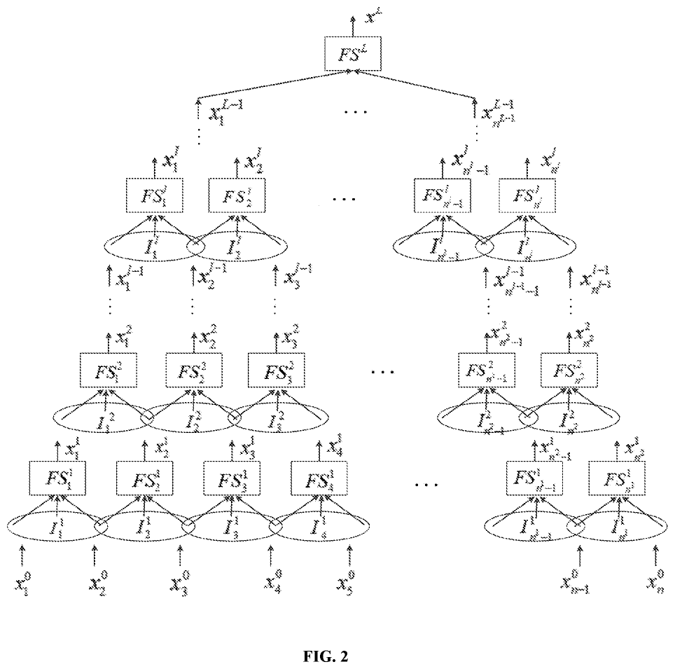

Fuzzy sub-systems are constructed on the basis of the least square method, and finally the deep hierarchical fuzzy system is built. The structure of the deep hierarchical fuzzy system is as shown in FIG. 2.

First, overall parameters of the system are set, and a number of layers L (set as 3), a moving step s (set as 2), and a length of a convolution window w (set as 2) are manually determined.

The feature vector PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅) in the training sampling set D₁ is taken as an input vector of the system, that is, (x₁⁰, x₂⁰, . . . , x₆⁰)=PFₘ, and the category label yₘ is taken as an output vector of each fuzzy sub-system.

An input-output data pair of an i-th fuzzy sub-system in a first layer is constructed: [xᵢ₋₁₎ₛ₊₁⁰(m), xₛ₊ᵢ⁰(m), . . . , x_{(i-1)s+w}⁰(m); yₘ]. The input-output data pair is obtained through a moving window having a length of w (a convolution operator). The window starts from first data of the input vector until all the data is covered, and the window moves by one step each time. 0 represents the input of the first layer.

A range [min x⁰, max x⁰] of the fuzzy sets is determined according to the data pair. In this range, the input vector can be further divided into q fuzzy sets A¹, A², . . . , A^{q}. The fuzzy sets A¹, A², . . . , A^{q} can be obtained by the existing calculation formula of the used triangular fuzzy sets (other fuzzy sets can also be used).

The i-th fuzzy sub-system in the first layer can be represented as: FSᵢ¹(x₍ᵢ₋₁₎ₛ₊₁⁰, xₛ₌ᵢ⁰, . . . , x_{(i-1)s+w}⁰)→xᵢ¹, and an expression of xᵢ¹ can be further obtained by using the existing standard formula and simplified as:

$$\begin{matrix}{x}_{i}^{1} = {FS}_{i}^{1} ( {x}_{( i - 1 ) s + 1}^{0} , {x}_{s + i}^{0} , … , {x}_{( i - 1 ) s + w}^{0} ) \\ = {\sum }_{{j}_{1} = 1}^{q} L {\sum }_{{j}_{w} = 1}^{q} {c}^{{j}_{1} L} {}^{{j}_{w}} {A}^{{j}_{1}} ( {x}_{( i - 1 ) s + 1}^{0} ) L {A}^{{j}_{w}} ( {x}_{( i - 1 ) s + w}^{0} )\end{matrix}$$

In the formula, FSᵢ¹ refers to the i-th fuzzy sub-system in the first layer, which can be seen in FIG. 2, xᵢ¹ refers to an output result obtained through actual running of the i-th fuzzy sub-system in the first layer, and c is a parameter matrix.

The parameter c^{j}^{₁}^{Lj}^{_{w}} in the formula above is designed by using the least square method and transformed into:

min S(c)=min∥xᵢ¹−yₘ∥²

In the formula, S(c) represents a function regarding parameter c, and yₘ represents a correct output result.

An optimal solution of the parameter is obtained.

The parameter matrix c is solved, the design of the i-th fuzzy sub-system in the first layer is completed, and the building of fuzzy sub-systems in the first layer is completed according to the method above.

The output xᵢ¹ of the first layer is taken as the input vector of fuzzy sub-systems in a second layer, the output vector is still yₘ, and the fuzzy sub-systems in the second layer are designed according to the same design method as that of the first layer. And so on, the design of fuzzy sub-systems in the last layer is completed, and the building of the deep hierarchical fuzzy system is completed.

The extraction of the feature vector on the basis of the local mean decomposition method and the classification by using the deep hierarchical fuzzy system constitute the recognition model.

By inputting the harmonic signal data in the test set D₂ into the recognition model and comparing the recognition result with the label, whether the accuracy of the recognition model can meet the requirement is tested. If the accuracy cannot meet the requirement, more sample data is needed to train the recognition model again until the accuracy can meet the requirement.

Module 3: Signal Recognition Module

This module is responsible for recognizing and analyzing the acquired harmonic signal data by using the constructed recognition model, determining a model of the detected equipment, and determining whether the inspected equipment is the environmental protection equipment and whether the inspected equipment is the corresponding environmental protection equipment.

The harmonic signal data acquired from the inspected equipment is inputted into the constructed recognition model, this model first extracts the feature vector of the harmonic signal data and then inputs the extracted feature vector into the deep hierarchical fuzzy system to obtain the category label for determining whether the inspected equipment is the corresponding environmental protection equipment, and display equipment outputs the analyzed recognition result.

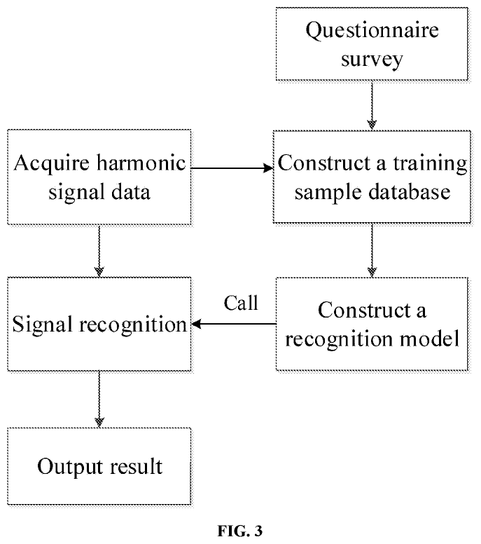

The overall steps of the present disclosure are as shown in FIG. 3.

The above description is merely preferred examples of the present disclosure and is not intended to limit the present disclosure, and various changes and modifications of the present disclosure may be made by those skilled in the art. Any modifications, equivalent substitutions, improvements, and the like made within the spirit and principle of the present disclosure should be included within the protection scope of the present disclosure.

1. A method for recognizing environmental protection equipment based on a deep hierarchical fuzzy algorithm, comprising the following steps:
(1) acquiring harmonic signal data of the environmental protection equipment by harmonic detectors, and acquiring type information of corresponding environmental protection equipment on site for constructing a training sample database;
(2) extracting a feature vector of the data in the training sample database by a local mean decomposition method, and training, by using the training sample database, a deep hierarchical fuzzy system constructed on the basis of a least square method, so as to construct a recognition model; and
(3) evaluating the inputted harmonic signal data by using the recognition model to determine whether inspected equipment is the corresponding environmental protection equipment.

2. The method for recognizing environmental protection equipment based on a deep hierarchical fuzzy algorithm according to claim 1, wherein step (1) comprises the following sub-steps:
acquiring several signal cycles of harmonic signal data xₘ(t), and then uploading this data to a cloud platform;
collecting the type information of the environmental protection equipment corresponding to all the harmonic detectors (equipment nodes m(m=1, 2, . . . , n)), and taking a type of the equipment as a category label yₘ, wherein yₘ∈{1, 2, . . . , k, k+1} (k≤n), label 1, 2, . . . , k represents k different types of environmental protection equipment, label k+1 represents non-environmental protection equipment, and correspondence is: m⇔yₘ⇔xₘ(t); and
constructing the training sample database D by using acquired harmonic signal data xₘ(t) and the category label yₘ corresponding to each harmonic signal data.

3. The method for recognizing environmental protection equipment based on a deep hierarchical fuzzy algorithm according to claim 1, wherein step (2) comprises the following sub-steps:
sub-step 1: extraction of the feature vector
performing local mean decomposition on each harmonic signal xₘ(t) in the training sample database to obtain a PF component, taking PF₁, PF₂, PF₃ components, obtaining an instantaneous amplitude aᵣ(t) and an instantaneous frequency fᵣ(t) of the PFᵣ (r=1,2,3) component of the harmonic signal xₘ(t), and further obtaining respective mean values a̅ᵣ̅(̅t̅)̅ and f̅ᵣ̅(̅t̅)̅ by using a mean value method; and constructing the feature vector PFₘ by using a̅ᵣ̅(̅t̅)̅ and f̅ᵣ̅(̅t̅)̅ of the PFᵣ component of the harmonic signal xₘ(t), that is, PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅);
sub-step 2: building of the deep hierarchical fuzzy system
first setting overall parameters of the system, and manually determining a number of layers L, a moving step s, and a length of a convolution window w;
taking the feature vector PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅) in the training sampling set D₁ as an input vector of the system, that is, (x₁⁰, x₂⁰, . . . , x₆⁰)=PFₘ, and taking the category label yₘ as an output vector of each fuzzy sub-system;
constructing an input-output data pair of an i-th fuzzy sub-system in a first layer: [x₍ᵢ₋₁₎ₛ₊₁⁰(m), xₛ₌ᵢ⁰(m), . . . , x_{(i-1)s+w}⁰(m); yₘ]; determining a range [min x⁰, max x⁰] of fuzzy sets according to the data pair, wherein in this range, the input vector can be further divided into q fuzzy sets A¹, A², . . . , A^{q}, wherein
the i-th fuzzy sub-system in the first layer can be represented as: FSᵢ¹(x₍ᵢ₋₁₎ₛ₊₁⁰, xₛ₊ᵢ⁰, . . . , x_{(i-1)s+w}⁰)→xᵢ¹, and an expression of xᵢ¹ can be further obtained by using an existing standard formula and simplified as:
$$\begin{matrix}{x}_{i}^{1} = {FS}_{i}^{1} ( {x}_{( i - 1 ) s + 1}^{0} , {x}_{s + i}^{0} , … , {x}_{( i - 1 ) s + w}^{0} ) \\ = {\sum }_{{j}_{1} = 1}^{q} L {\sum }_{{j}_{w} = 1}^{q} {c}^{{j}_{1} L} {}^{{j}_{w}} {A}^{{j}_{1}} ( {x}_{( i - 1 ) s + 1}^{0} ) L {A}^{{j}_{w}} ( {x}_{( i - 1 ) s + w}^{0} )\end{matrix}$$
designing the parameter c^{j}^{₁}^{Lj}^{_{w}} in the formula above by using the least square method and transforming same into:
min S(c)=min∥xᵣ¹−yₘ∥²
and obtaining an optimal solution thereof;
solving a parameter matrix c, completing the design of the i-th fuzzy sub-system in the first layer, and completing the building of fuzzy sub-systems in the first layer according to the method above; and
taking output xᵢ¹ of the first layer as the input vector of fuzzy sub-systems in a second layer, the output vector being still yₘ, and designing the fuzzy sub-systems in the second layer according to the same design method as the design method of the first layer; and so on, completing the design of fuzzy sub-systems in the last layer, and completing the building of the deep hierarchical fuzzy system.

4. The method for recognizing environmental protection equipment based on a deep hierarchical fuzzy algorithm according to claim 3, wherein in step (2), the data in the training sample database D is divided into two parts: a training set D₁ and a test set D₂, and both the training set D₁ and the test set D₂ are subjected to the sub-step of extraction of the feature vector; by inputting the harmonic signal data in the test set D₂ into the recognition model and comparing a recognition result with the label, whether the accuracy of the recognition model can meet the requirement is tested; and if the accuracy cannot meet the requirement, more sample data is needed to train the recognition model again until the accuracy can meet the requirement.

5. The method for recognizing environmental protection equipment based on a deep hierarchical fuzzy algorithm according to claim 1, wherein in step (3), the harmonic signal data acquired from the inspected equipment is inputted into the constructed recognition model, this model first extracts the feature vector of the harmonic signal data and then inputs the extracted feature vector into the deep hierarchical fuzzy system to obtain the category label for determining whether the inspected equipment is the corresponding environmental protection equipment, and display equipment outputs the analyzed recognition result.

6. A system for recognizing environmental protection equipment based on a deep hierarchical fuzzy algorithm, configured to perform, when being executed, the steps of the method for recognizing environmental protection equipment based on a deep hierarchical fuzzy algorithm according to claim 1, wherein the system comprises:
a data acquisition module configured to perform step (1) of the method;
a recognition model construction module configured to perform step (2) of the method; and
a signal recognition module configured to perform step (3) of the method.

7. The system according to claim 6, wherein step (1) comprises the following sub-steps:
acquiring several signal cycles of harmonic signal data xₘ(t), and then uploading this data to a cloud platform;
collecting the type information of the environmental protection equipment corresponding to all the harmonic detectors (equipment nodes m(m=1, 2, . . . , n)), and taking a type of the equipment as a category label yₘ, wherein yₘ∈{1, 2, . . . , k, k+1} (k≤n), label 1, 2, . . . , k represents k different types of environmental protection equipment, label k+1 represents non-environmental protection equipment, and correspondence is: m⇔yₘ⇔xₘ(t); and
constructing the training sample database D by using acquired harmonic signal data xₘ(t) and the category label yₘ corresponding to each harmonic signal data.

8. The system according to claim 6, wherein step (2) comprises the following sub-steps:
sub-step 1: extraction of the feature vector
performing local mean decomposition on each harmonic signal xₘ(t) in the training sample database to obtain a PF component, taking PF₁, PF₂, PF₃ components, obtaining an instantaneous amplitude aᵣ(t) and an instantaneous frequency fᵣ(t) of the PFᵣ (N=1,2,3) component of the harmonic signal xₘ(t) and further obtaining respective mean values a̅ᵣ̅(̅t̅)̅ and f̅ᵣ̅(̅t̅)̅ by using a mean value method; and constructing the feature vector PFₘ by using a̅ᵣ̅(̅t̅)̅ and f̅ᵣ̅(̅t̅)̅ of the PFᵣ component of the harmonic signal xₘ(t), that is, PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅);
sub-step 2: building of the deep hierarchical fuzzy system
first setting overall parameters of the system, and manually determining a number of layers L, a moving step s, and a length of a convolution window w;
taking the feature vector PFₘ=(a̅₁̅(̅t̅)̅, f̅₁̅(̅t̅)̅, a̅₂̅(̅t̅)̅, f̅₂̅(̅t̅)̅, a̅₃̅(̅t̅)̅, f̅₃̅(̅t̅)̅) in the training sampling set D₁ as an input vector of the system, that is, (x₁⁰, x₂⁰, . . . , x₆⁰)=PFₘ, and taking the category label yₘ as an output vector of each fuzzy sub-system;
constructing an input-output data pair of an i-th fuzzy sub-system in a first layer: [x₍ᵢ₋₁₎ₛ₊₁⁰(m), xₛ₊ᵢ⁰(m), . . . , x_{(i-1)s+w}⁰(m); yₘ]; determining a range [min x⁰,max x⁰] of fuzzy sets according to the data pair, wherein in this range, the input vector can be further divided into q fuzzy sets A¹, A², . . . , A^{q}, wherein
the i-th fuzzy sub-system in the first layer can be represented as: FSᵢ¹(x₍ᵢ₋₁₎ₛ₊₁⁰, xₛ₊ᵢ⁰, . . . , x_{(i-1)s+w}⁰)→xᵢ¹, and an expression of xᵢ¹ can be further obtained by using an existing standard formula and simplified as:
$$\begin{matrix}{x}_{i}^{1} = {FS}_{i}^{1} ( {x}_{( i - 1 ) s + 1}^{0} , {x}_{s + i}^{0} , … , {x}_{( i - 1 ) s + w}^{0} ) \\ = {\sum }_{{j}_{1} = 1}^{q} L {\sum }_{{j}_{w} = 1}^{q} {c}^{{j}_{1} L} {}^{{j}_{w}} {A}^{{j}_{1}} ( {x}_{( i - 1 ) s + 1}^{0} ) L {A}^{{j}_{w}} ( {x}_{( i - 1 ) s + w}^{0} )\end{matrix}$$
designing the parameter c^{j}^{₁}^{Lj}^{_{w}} in the formula above by using the least square method and transforming same into:
min S(c)=min∥xᵢ¹−yₘ∥²
and obtaining an optimal solution thereof;
solving a parameter matrix c, completing the design of the i-th fuzzy sub-system in the first layer, and completing the building of fuzzy sub-systems in the first layer according to the method above; and
taking output xᵢ¹ of the first layer as the input vector of fuzzy sub-systems in a second layer, the output vector being still yₘ, and designing the fuzzy sub-systems in the second layer according to the same design method as the design method of the first layer; and so on, completing the design of fuzzy sub-systems in the last layer, and completing the building of the deep hierarchical fuzzy system.

9. The system according to claim 8, wherein in step (2), the data in the training sample database D is divided into two parts: a training set D₁ and a test set D₂, and both the training set D₁ and the test set D₂ are subjected to the sub-step of extraction of the feature vector; by inputting the harmonic signal data in the test set D₂ into the recognition model and comparing a recognition result with the label, whether the accuracy of the recognition model can meet the requirement is tested; and if the accuracy cannot meet the requirement, more sample data is needed to train the recognition model again until the accuracy can meet the requirement.

10. The system according to claim 6, wherein in step (3), the harmonic signal data acquired from the inspected equipment is inputted into the constructed recognition model, this model first extracts the feature vector of the harmonic signal data and then inputs the extracted feature vector into the deep hierarchical fuzzy system to obtain the category label for determining whether the inspected equipment is the corresponding environmental protection equipment, and display equipment outputs the analyzed recognition result.
